(19) United States
(12) Patent Application Publication
(10) Pub. No.: US 2025/0078080 A1
(43) Pub. Date: Mar. 6, 2025

(54) Electronic Devices and Corresponding Methods for Presenting Fraud Warnings for One Time Password Exchanges

(71) Applicant: Motorola Mobility LLC, Chicago, IL (US)

(72) Inventors: Amit Kumar Agrawal, Bangalore (IN); Hariprasad Shanbhogue Alampady, Bangalore (IN); Bhavana Bhat, Bangalore (IN)

(21) Appl. No.: 18/239,630

(22) Filed: Aug. 29, 2023

(51) Int. Cl. G06Q 20/40; G06Q 20/38

(52) U.S. Cl. CPC G06Q 20/4016; G06Q 20/3821

(57) ABSTRACT

An electronic device includes a communication device, a memory, and a user interface. The electronic device includes one or more processors operable with the memory, the user interface, and the communication device. The memory is configured to store an aggregated list of electronic commerce orders made using credentials of an authorized user of the electronic device. When the communication device receives a one-time password, the one or more processors are configured to determine, using the aggregated list, whether the one-time password corresponds to any of the electronic commerce orders stored in the aggregated list. When the one-time password fails to correspond to any of the electronic commerce orders in the aggregated list, the one or more processors are configured to present a prompt comprising a fraud warning indicating that use of the one-time password is likely fraudulent.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, scammers and other miscreants have begun to try and exploit security gaps in either the financial applications of the device or user behavior to commit crimes and steal money. It would be advantageous to have improved devices and systems to prevent situations such as this from occurring.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more explanatory method steps in accordance with one or more embodiments of the disclosure.

FIG. 2 illustrates one explanatory electronic device in accordance with one or more embodiments of the disclosure.

FIG. 3 illustrates one or more method steps in accordance with one or more embodiments of the disclosure.

FIG. 4 illustrates one explanatory method in accordance with one or more embodiments of the disclosure.

FIG. 5 illustrates another explanatory method in accordance with one or more embodiments of the disclosure.

FIG. 6 illustrates one explanatory signal flow diagram in accordance with one or more embodiments of the disclosure.

FIG. 7 illustrates one or more embodiments of the disclosure.

FIG. 8 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining whether the receipt of an one-time password associated with an electronic commerce transaction corresponds to fraudulent activity and, where the receipt of the one-time password associated with the electronic commerce transaction corresponds with the fraudulent activity, presenting, on a user interface by one or more processors, a prompt comprising a fraud warning indicating that use of the one-time password is likely fraudulent. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of determining whether a received one-time password corresponds to an aggregated list comprising electronic commerce orders made using credentials of an authorized user of an electronic device and, when the one-time password fails to correspond to any of the electronic commerce orders in the aggregated list, presenting a prompt comprising a fraud warning indicating that use of the one-time password is likely fraudulent as described herein. The non-processor circuits may include, but are not limited to, a radio receiver, a radio transmitter, signal drivers, clock circuits, power source circuits, and user input devices.

As such, these functions may be interpreted as steps of a method to perform the determination of whether a received one-time password corresponds to an electronic commerce order made using a credential of an authorized user of an electronic device stored in an aggregated list of electronic commerce orders and whether the one-time password originates from an origination address differing from origination addresses associated with electronic commerce orders in the aggregated list and, where either is not the case, presenting a prompt on a user interface comprising a fraud warning that indicates use of the one-time password is likely fraudulent. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods, electronic devices, and systems that warn users of potentially fraudulent activity when one-time passwords are received. Embodiments of the disclosure contemplate that scammers will sometimes attempt to defraud targets using the following scheme: initially, the fraudster will allege to have a package or shipment for the target that was shipped “collect on delivery” (C.O.D.). If the target attempts to open the package to inspect whatever may be inside, the scammer demands that payment be made first. If the target falls for the scam and attempts to pay, the scammer will transmit a link to what appears to be a legitimate e-commerce portal or website but that actually directs the target to a fraudulent portal or website. When the target logs in, this is a ruse—the login credentials are merely transferred to the scammer's device where the scammer uses them to login as if the scammer was the target. Since most people now use two-factor authentication, the fact that the scammer logs in causes a one-time password to be delivered to the target's electronic device. The scammer will then ask for the one-time password as “confirmation” of payment. If the target shares the one-time password, the scammer now has all the information necessary to ravage the target's account.

In short, the scheme is to make the target think they are logging into a legitimate website or e-commerce portal while instead transferring their credentials to the scammer. When the one-time password is received, the scammer attempts to obtain it from the target to fully login to one or more e-commerce, banking, or financial accounts of the target. Consider the following example:

In a fake parcel scam or collect on delivery scam, scammers dress as delivery persons. When delivering a package, the scammer will attempt to get a target to open a link on a smartphone and/or share a one-time password that is received. The scammer uses this information to clone the smartphone or access the target's accounts.

These scams are often carried out by people who work closely with delivery people or last-mile delivery agencies. Since they have access to delivery services, it is easy to obtain a target's address, phone number, order frequency, and—most importantly—how frequently a target may order expensive items from e-commerce sites.

Such scammers rely upon the fact that the target likely has a parcel on its way that is arriving with payment to be made “collect on delivery.” If a target happens not to have such a parcel on the way, the scammer shows the target a bogus label on the package with the target's name and address. If the target attempts to open the package in front of the scammer, the scammer insists that the target pay first.

During this time, the scammer will attempt to get the target to pay online, via a unified payments interface (UPI), or through some other link. If the target falls for the scam and agrees to pay, the scammer will send the target a link via a short message system text that will lead to a page that looks to be a legitimate e-commerce site. Once the target enters their credentials, this triggers the delivery of a one-time password. The scammer will demand that for confirmation. If the target provides the one-time password, the target is sunk, as this provides the scammer with unhindered access to the smartphone and/or e-commerce, banking, or financial accounts.

Advantageously, embodiments of the disclosure provide a solution to this problem that would present a prompt to the target warning the target that the use of the one-time password is likely fraudulent. In one or more embodiments, one or more processors of an electronic device maintain an aggregated list in memory that comprises electronic commerce orders made using credentials of an authorized user of the electronic device. This aggregated list can ingest any and all information related to the electronic commerce orders that is received by the electronic device, examples of which include payment modes associated with the electronic commerce orders, text message notifications regarding the electronic commerce orders, email notifications regarding the electronic commerce orders, vendor short message service addresses associated with the emails and text messages corresponding to the electronic commerce orders, delivery statuses of the electronic commerce orders, electronic communications relating to gifts purchased for, and being sent to, the authorized user of the electronic device, or other communications related to the electronic commerce orders.

In one or more embodiments, the one or more processors detect, from a communication device of the electronic device, receipt of a one-time password associated with an electronic commerce transaction. The delivery of such a one-time password occurs when the authorized user of the electronic device legitimately logs into their accounts in most cases. However, as noted above, it can also be triggered by a scammer who is attempting to access another person's accounts.

In one or more embodiments, the one or more processors determine whether the receipt of the one-time password associated with the electronic commerce transaction corresponds to fraudulent activity. Where the receipt of the one-time password associated with the electronic commerce transaction corresponds to the fraudulent activity, the one or more processors present, at a user interface of the electronic device, a prompt comprising a fraud warning indicating that the use of the one-time password is likely fraudulent.

The one or more processors can determine whether the receipt of the one-time password associated with an electronic commerce transaction corresponds to fraudulent activity in a variety of ways. Illustrating by example, in one or more embodiments the aggregated list of electronic commerce orders comprises a payment mode used for each electronic commerce order. When the receipt of the one-time password fails to correspond with any of the payment modes stored within the aggregated list, the one or more processors can determine that use of the one-time password is likely fraudulent.

Similarly, in one or more embodiments the aggregated list comprises a vendor short message service address for each electronic commerce order. In one or more embodiments the one or more processors determine whether the one-time password originates from any of the vendor short message service addresses stored in the aggregated list. In one or more embodiments, when the one-time password fails to originate from one of these vendor short message service addresses, the one or more processors present a prompt on a user interface indicating that use of the one-time password is likely fraudulent.

In one or more embodiments, the aggregated list also maintains a vendor telephone number for each electronic commerce order. In one or more embodiments, when a link used to login fails to include a vendor telephone number included in the aggregated list, the one or more processors can present a prompt on a user interface indicating that use of any one-time password received from that vendor is likely fraudulent.

Embodiments of the disclosure can even be used for gift orders. Illustrating by example, in one or more embodiments the communication device of the electronic device can receive electronic signals indicating that one or more gift orders for the authorized user of the electronic device have been made by one or more remote electronic devices. Accordingly, the one or more processors can store communications corresponding to the one or more gift orders in the aggregated list. When receipt of a one-time password fails to correspond to any of these gift orders, the one or more processors can present a prompt on a user interface indicating that use of the one-time password is likely fraudulent.

In one or more embodiments, the aggregated list also maintains a delivery status for each electronic commerce order. In one or more embodiments, when receipt of the one-time password fails to correspond to any delivery statuses stored in the aggregated list, the one or more processors can present a prompt on a user interface indicating that use of the one-time password is likely fraudulent.

In still other embodiments, the one or more processors can look at data within the aggregated list to determine whether receipt of a one-time password is associated with fraudulent activity. Illustrating by example, in one or more embodiments the one or more processors determine whether an electronic commerce order stored in the aggregated list identifies the one-time password. Where it does not, the one or more processors can present a prompt on a user interface indicating that use of the one-time password is likely fraudulent. Similarly, where the one-time password—or the e-commerce portal or website used to trigger receipt of the one-time password—is abnormal when compared to the electronic commerce orders stored in the aggregated list, the one or more processors can present a prompt on a user interface indicating that use of the one-time password is likely fraudulent. Illustrating by example, if the e-commerce portal or website has malicious code, suspicious links, or other content that does not correspond to vendor short message service addresses stored in the aggregated list, the one or more processors can determine that use of the one-time password is likely fraudulent.

Some scammers are really good and can even mimic actual orders by showing up with packages just at the time a person is expecting a bona fide order. Embodiments of the disclosure still work in such situations.

Illustrating by example, in one or more embodiments when the one-time password corresponds to an electronic commerce order stored in the aggregated list, the one or more processors can determine whether payment has already been made for that particular electronic commerce order. Where it has, the one or more processors can present a prompt on a user interface indicating that use of the one-time password is likely fraudulent.

In one or more embodiments, an electronic device comprises a communication device, a memory, and a user interface. In one or more embodiments, the electronic device comprises one or more processors that are operable with the memory, the user interface, and the communication device.

In one or more embodiments, the memory is configured to store an aggregated list comprising electronic commerce orders made using credentials of an authorized user of the electronic device. In one or more embodiments, when the communication device receives a one-time password, the one or more processors are configured to determine, using the aggregated list, whether the one-time password corresponds to any of the electronic commerce orders stored within the aggregated list. When the one-time password fails to correspond to any of the electronic commerce orders in the aggregated list, in one or more embodiments the one or more processors are configured to present a prompt comprising a fraud warning indicating that use of the one-time password is likely fraudulent.

In one or more embodiments, the one or more processors are configured to determine whether the one-time password corresponds to any of the electronic commerce orders stored in the aggregated list by comparing an origination address parsed from the one-time password with a vendor short message service addresses associated with electronic commerce orders stored in the aggregated list. When the origination address fails to correspond to one of the vendor short message service addresses, the one or more processors can present a prompt on a user interface indicating that use of the one-time password is likely fraudulent.

In one or more embodiments the prompt comprises a user actuation target that allows the fraud warning to be overridden. When a user actuates the user actuation target, the one or more processors utilize the one-time password. Otherwise, the one or more processors are configured to preclude use of the one-time password in the absence of actuation of the user actuation target in one or more embodiments.

In one or more embodiments, a method in an electronic device comprises a communication device receiving a one-time password associated with an electronic commerce transaction. Thereafter, one or more processors determine whether the one-time password corresponds to an electronic commerce order made using credentials of an authorized user of the electronic device stored in an aggregated list of electronic commerce orders in a memory of the electronic device. In one or more embodiments. The one or more processors also determine whether the one-time password originates from an origination address differing from origination addresses associated with any of the electronic commerce orders stored in the aggregated list.

In one or more embodiments, when either the one-time password fails to correspond to the electronic commerce order or the one-time password corresponds to the electronic commerce order and the one-time password fails to originate from an origination address associated with any of the electronic commerce orders stored in the aggregated list, one or more processors present, on a user interface, a prompt comprising a fraud warning indicating that use of the one-time password is likely fraudulent. In one or more embodiments, the prompt instructs the authorized user to examine the product associated with the electronic commerce transaction before the one-time password can be revealed.

Advantageously, embodiments of the disclosure alert a potential fraud victim that the use of a one-time password is likely fraudulent before the one-time password is shared or used. This allows the potential fraud victim to avoid becoming an actual fraud victim.

Embodiments of the disclosure contemplate that many modern electronic devices include both financial applications and shopping applications. Illustrating by example, Motorola Mobility has launched a banking application called DIMO.sup.TM in Brazil. This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.TM are leading to users simply ceasing to carry paper currency or coins. Moreover, applications like DIMO.sup.TM have caused people to stop carrying physical credit and debit cards as well since the credit and debit card account information can simply be loaded into a smartphone, with near-field and other communication devices allowing direct transactions of money electronically.

Embodiments of the disclosure also contemplate that ensuring that such financial applications are fully fraud proof has been challenging in the past. This is true even for well-established financial technology firms. While many additional features and mechanisms have been added to financial applications, examples of which include multi-factor authentication, encryption, and the like, miscreants are still able to make fraudulent transactions. Such transactions seem to be in the news every day.

In many situations, users of financial applications become victims when fraudsters pose as delivery men with packages that mysteriously arrive “collect on delivery.” However, such users can become victims in other ways as well. They may download unsecure applications, visit fraudulent websites, or take other actions where they believe to be acting safely and are instead walking right into the trap of a nefarious actor.

In some situations, victims are made to believe that a caller or messenger is legitimate, only to find that they are really crooks when a financial transaction initiated by the victim is directed to a fraudulent account. Indeed, embodiments of the disclosure are directed to situations in which a fraudster asks a target to login to the purported website or portal of a known vendor or bank to trigger the delivery of a one-time password. When the website or portal really transfers login credentials to the fraudster, any revelation of the one-time password allows the fraudster unfettered access to the target's account at the vendor bro bank.

Embodiments of the disclosure provide a solution to this madness by providing contextually relevant alerts when a potentially fraudulent transaction is occurring. Advantageously, embodiments of the disclosure help to prevent potential victims from becoming actual victims by preventing them from falling into traps laid by fraudsters. Other advantages will be described below. Still others will be obvious to those of ordinary skill in the art having the benefit of this disclosure.

In addition to presenting prompts warning of fraudulent activity, other steps can be performed as well. Illustrating by example, in one or more embodiments the one or more processors can optionally present a history of fraudulent transactions associated with any account or person deemed to be suspicious.

In one or more embodiments, information associated with financial transactions that are likely fraudulent can be stored in a functional database. In one or more embodiments, if a sufficient number of verified electronic device users trigger the same fraud warning, this backend system managing the functional database can use machine learning to avoid providing such fraud warning or reduce the intensity level of the fraud warning to a basic warning.

In one or more embodiments, the backend can increase the severity of the alert in detection of additional information requested by the authorized user of the electronic device such as a screenshot of the stranger as it will have personal and sensitive information. As noted above, in one or more embodiments the one or more processors of the electronic device—or the backend—can mask or filter sensitive information to further protect user data in the event an authorized user of an electronic device attempts to share a one-time password.

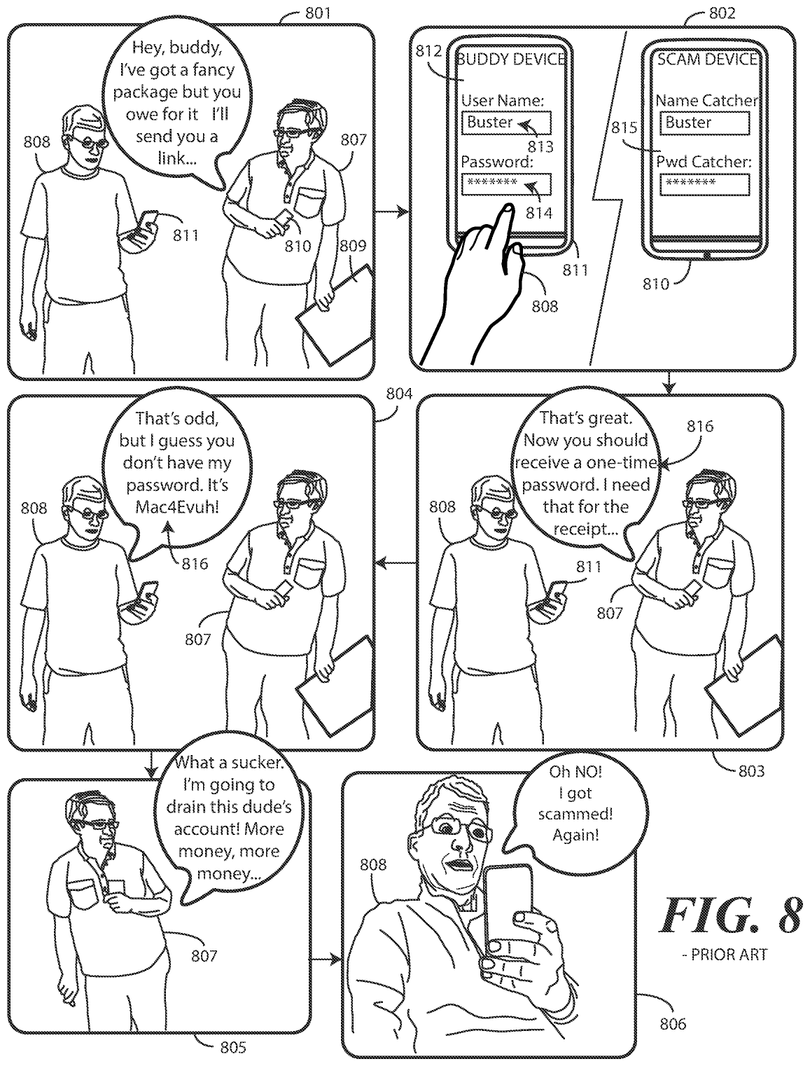

Turning first to FIG. 8, illustrated therein are one or more method steps illustrating how fraud can occur in prior art systems, using prior art devices and methods. Beginning at step 801, a fraudster 807 dressed as a delivery man has arrived at the home of a target 808 with what is alleged to be a “big fancy” package 809. The fraudster 807 initiates a scam by stating, “Hey, buddy, I've got a fancy package for you, but you owe for it,” implying that the big fancy package 809 was sent collect on delivery. To facilitate payment, the fraudster 807 tells the target 808 that he will send a “payment link” from his electronic device 810 to the electronic device 811 belonging to the target 808.

As shown at step 802, the link the fraudster 807 sent to the target 808 appears to direct the target's electronic device 811 to a seemingly legitimate website 812 associated with an e-commerce vendor with which the target 808 has done business. Since the seemingly legitimate website 812 is actually not legitimate, when the target 808 enters his username 813 and password 814, this information is transferred to the electronic device 810 belonging to the fraudster 807 where it is entered into a truly legitimate website 815 associated with the e-commerce vendor with which the target 808 has done business. Accordingly, it is the fraudster 807 who is able to login to the target's account at the e-commerce vendor, not the target 808.

Fortunately, the target 808 is at least trying to be safe when shopping and conducting financial transactions on-line and has turned on “two-factor authentication” (TFA) at the e-commerce vendor's website 815. Accordingly, the fraudster's login using the target's username 813 and password 814 triggers the delivery of a one-time password 816, as shown at step 803. Since the one-time password 816 is delivered to the electronic device 811 belonging to the target 808, the fraudster 807 needs access to it to complete his nefarious scheme. Accordingly, as shown at step 803, the fraudster 807 asks the target 808 for the one-time password 816. To justify this weirdness, the fraudster 807 alleges he needs the one-time password 816 “for the receipt.”

As shown at step 804, the target 808 thinks, “that's odd.” However, the target 807 falls for the scam because he believes that the fraudster 807 is a legitimate delivery man and has no ideas the seemingly legitimate website 812 was nothing more than a username 813 and password 814 redirector that send these credentials directly to the electronic device 810 belonging to the fraudster 807. Believing that the fraudster 807 has no idea what the password 814 is, in a true George Costanza caught in the automated teller machine moment the target 808 “shouts out his code, man,” telling the fraudster 807 that the one-time password 816 is Mac4Evuh!

At step 805, the fraudster 807 now has all the information to hack the target's e-commerce account. Laughing fiendishly and knowing that the big fancy package 809 was nothing but a box of shredded Enron stock certificates, the fraudster 807 says, “What a sucker. I'm going to drain this dude's account.” Paraphrasing the iconic Marc Springer of Snortn' Boar Transport, the fraudster 807 starts chanting, “More money, more money, more money!” As shown at step 806, the poor target 808 now understands he has been scammed. Downtrodden and depressed, he laments all the work that must be done to try and get his precious money back.

Sadly, situations such as this are all too common. Fortunately, embodiments of the disclosure provide a solution to these problems. In one or more embodiments, a method in an electronic device comprises maintaining, by one or more processors in a memory of the electronic device, an aggregated list comprising electronic commerce orders using credentials of an authorized user of the electronic device and any and all correspondence received by the electronic device corresponding thereto.

One or more processors then detect, using a communication device of the electronic device, receipt of a one-time password associated with an electronic commerce transaction. In most cases, this will be not fraudulent, as the two-factor authentication will trigger a one-time password when the authorized user of the electronic device logs into a legitimate e-commerce portal or website. However, to prevent the authorized user from falling victim to the “shout out your code” scam described above, in one or more embodiments the one or more processors of the electronic device determine whether the receipt of the one-time password associated with the electronic commerce transaction allegedly necessitating the one-time password corresponds to fraudulent activity.

Where the receipt of the one-time password associated with the electronic commerce transaction corresponds to fraudulent activity, the one or more processors present a prompt at a user interface of the electronic device comprising a fraud warning indicating that use of the one-time password is likely fraudulent. In one or more embodiments, the prompt includes a user actuation target that, when actuated, precludes the one-time password from being revealed. In some embodiments, the prompt also includes a user actuation target allowing the authorized user of the electronic device to override the fraud warning and reveal the one-time password.

In one or more embodiments, the electronic device creates and maintains an aggregated list of all recent electronic commerce orders from a set of transactions. The one or more processors of the electronic device then can correlate communications associated with the electronic commerce orders, including order histories from all e-commerce applications operating on the electronic device or any connected device or accounts, payment modes for each electronic commerce order, and text messages comprising notifications of orders with the vendor short message service address or phone number from which the text messages originated, as well as any communication shared to the electronic device relating to any gift being ordered or delivered to the authorized user of the electronic device. Additionally, the delivery status for each electronic commerce order, including the potential delivery date or delivered status of the electronic commerce order, can be stored in the aggregated list as well.

When the receipt of a one-time password is detected as pertaining to an electronic commerce order, the one or more processors can determine if the one-time password is associated with a potential delivery scam. In one or more embodiments, the one or more processors do this by determining that an incoming communication contains an unusual link. Illustrating by example, if a purported delivery man transmits a link to the electronic device, the one or more processors can determine whether this is a legitimate e-commerce portal or website by comparing links and domains to vendor domains and vendor short message service addresses in the aggregated list. The one or more processors can determine that the link is unusual by machine learning from previous verified one-time password communications.

In some embodiments, the one or more processors can determine that the incoming communication is not from a vendor short message service address. In other embodiments, the one or more processors can determine that there is no matching delivery to the one-time password in the aggregated list. The one or more processors can determine that there is no matching payment mode in the aggregated list, as well as determining whether a particular package was previously paid for with no additional money due.

In one or more embodiments, when a delivery scam is detected, the one or more processors can create a user interface flow that presents a warning message. The warning message may insist that the package be opened before the one-time password is used. In other embodiments, the one-time password is made accessible only after a second level of authentication once a person has consented to the potential risk. Illustrating by example, the prompt providing the warning message may include a user actuation target that allows the fraud warning to be overridden. In response to actuation of the user actuation target, the one or more processors may request secondary authentication of the authorized user of the electronic device prior to allowing the one-time password to be used.

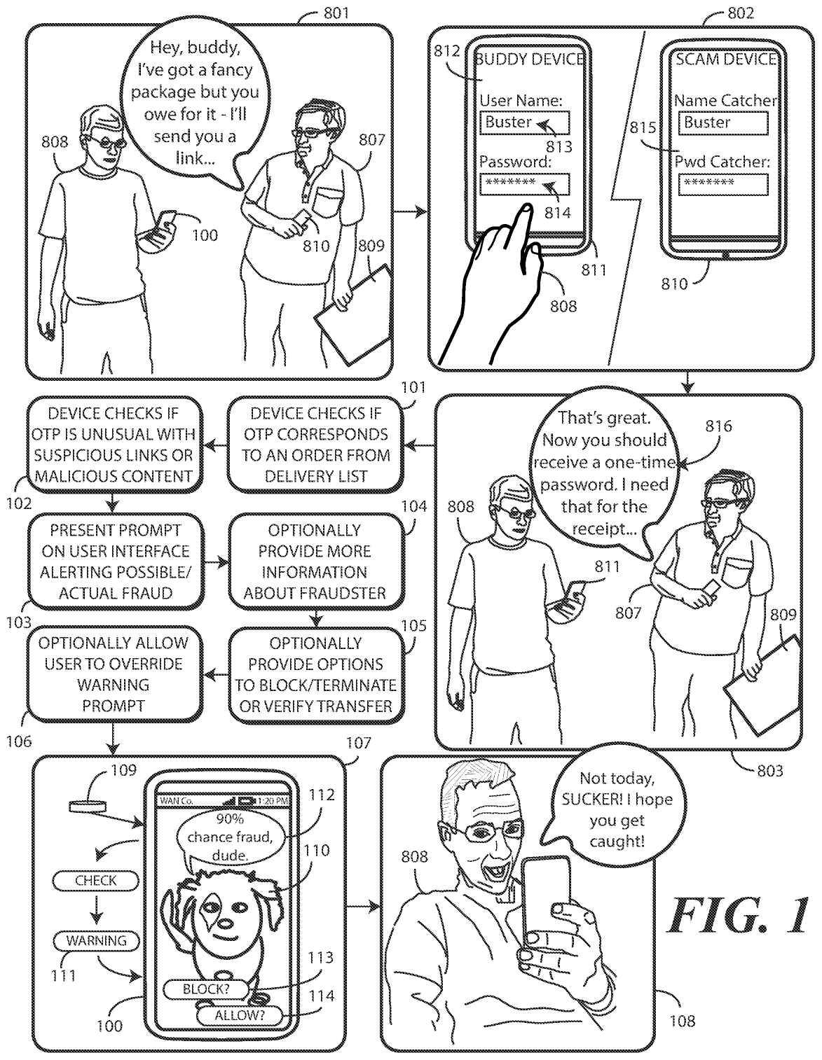

Turning now to FIG. 1, illustrated therein are one or more method steps depicting how the dreadful situation illustrated in FIG. 8 can be avoided using embodiments of the disclosure.

FIG. 1 begins at step 801 of FIG. 8. Once again, at step 801 a fraudster 807 has dressed as a delivery man and has arrived at the home of a target 808 with what is alleged to be a “big fancy” package 809. The fraudster 807 again initiates a scam by stating, “Hey, buddy, I've got a fancy package for you, but you owe for it,” implying that the big fancy package 809 was sent collect on delivery. To facilitate payment, the fraudster 807 tells the target 808 that he will send a payment link from his electronic device 810 to the electronic device 100 belonging to the target 808. Fortunately, this time the target 808 is using an electronic device 100 configured in accordance with embodiments of the disclosure.

As shown at step 802, the link the fraudster 807 sent to the target 808 again appears to direct the target's electronic device 100 to a seemingly legitimate website 812 associated with an e-commerce vendor with which the target 808 has done business. When the target 808 enters his username 813 and password 814, this information is transferred to the electronic device 810 belonging to the fraudster 807 where it is entered into a truly legitimate website 815 associated with the e-commerce vendor with which the target 808 has done business. Accordingly, the fraudster 807 is able to login to the target's account at the e-commerce vendor.

The fraudster's login using the target's username 813 and password 814 triggers the delivery of a one-time password 816, as shown at step 803. Since the one-time password 816 is delivered to the electronic device 100 belonging to the target 808, the fraudster 807 needs access to it to complete his nefarious scheme. Accordingly, as shown at step 803, the fraudster 807 asks the target 808 for the one-time password 816.

The one or more processors of the electronic device 100 detect, using a communication device, the receipt of the one-time password 816 associated with the electronic commerce transaction represented by the big fancy package 809 at step 803. In one or more embodiments, the one or more processors of the target's electronic device 100 maintain, in a memory of the electronic device, an aggregated list 109 as shown at step 107.

In one or more embodiments, the aggregated list 109 comprises electronic commerce orders made using credentials of the target 808, who is an authorized user of the electronic device 100. At step 101, the one or more processors of the electronic device 100 can compare the one-time password 816 to the electronic commerce orders stored in the aggregated list 109 to determine whether the one-time password 816 corresponds to an electronic commerce order stored in the aggregated list 109. Where the one-time password 816 fails to correspond with an electronic commerce order stored in the aggregated list 109, as determined at step 101, the one or more processors can determine that the one-time password 816 corresponds to fraudulent activity.

This correspondence check performed at step 101 can be performed in a variety of ways, as the aggregated list 109 can store a variety of information as noted above. Illustrating by example, in one or more embodiments, the aggregated list 109 maintains a payment mode for each electronic commerce order. In one or more embodiments, the determining whether the one-time password 816 corresponds to fraudulent activity occurring at step 101 comprises determining that the one-time password 816 fails to correspond to any payment mode stored in the aggregated list 109.

In one or more embodiments, the aggregated list 109 maintains a vendor short message service address for each electronic commerce order. In one or more embodiments, the determining whether the one-time password 816 corresponds to fraudulent activity occurring at step 101 comprises determining that the one-time password 816 fails to originate from any vendor short message service address stored in the aggregated list 109.

In one or more embodiments, the aggregated list 109 maintains a vendor telephone number for each electronic commerce order. In one or more embodiments, the determining whether the one-time password 816 corresponds to fraudulent activity occurring at step 101 comprises determining that the one-time password 816 fails to be sent from a vendor telephone number stored in the aggregated list 109.

In one or more embodiments, the aggregated list 109 maintains a delivery status for each electronic commerce order. In one or more embodiments, the determining whether the one-time password 816 corresponds to fraudulent activity occurring at step 101 comprises determining that the time of receipt of the one-time password 816 fails to correspond to a delivery of an electronic commerce order. Said differently, in one or more embodiments the determining whether the one-time password 816 corresponds to fraudulent activity occurring at step 101 comprises determining a time of receipt of the one-time password 816 fails to correspond to any delivery statuses stored in the aggregated list 109. Step 101 can also comprise determining whether an electronic commerce order stored within the aggregated list 109 identifies the one-time password 816.

In one or more embodiments, the one or more processors of the electronic device 100 also correlate communications associated with the electronic commerce orders in the aggregated list 109, including order histories from all e-commerce applications operating on the electronic device 100 or any connected device or accounts and text messages comprising notifications of orders with the vendor short message service address or phone number from which the text messages originated. Gift orders directed to the target 808 can be stored in the aggregated list 109, as can payments made for orders and delivery histories. Other examples of information that can be stored in the aggregated list 109 will be obvious to those of ordinary skill in the art having the benefit of this disclosure.

Thus, at step 101 the one or more processors of the electronic device 100 determine whether the receipt of the one-time password 816, detected being received at step 803 and associated with the alleged electronic commerce transaction represented by the big fancy package 809, corresponds to fraudulent activity. Where the aggregated list 109 comprises a payment mode used for each electronic commerce order stored in the aggregated list 109 and the receipt of the one-time password 816 fails to correspond with any of the payment modes stored within the aggregated list 109, the one or more processors of the electronic device 100 can determine that use of the one-time password 816 is likely fraudulent.

Similarly, when the aggregated list 109 comprises a vendor short message service address for each electronic commerce order stored in the aggregated list 109 and the one-time password 816 fails to originate from one of these vendor short message service addresses, the one or more processors of the electronic device 100 can determine that use of the one-time password 816 is likely fraudulent.

When the aggregated list 109 also maintains a vendor telephone number for each electronic commerce order and when a link used to login fails to include a vendor telephone number included in the aggregated list 109, the one or more processors of the electronic device 100 can determine that use of any one-time password received from that vendor is likely fraudulent. When the electronic device 100 receives electronic signals indicating that one or more gift orders for the authorized user of the electronic device 100 have been made by one or more remote electronic devices, the one or more processors of the electronic device 100 can store the one or more gift orders in the aggregated list 109. When receipt of the one-time password 816 fails to correspond to any of these gift orders, the one or more processors can determine that use of any one-time password 816 received from that vendor is likely fraudulent.

When the aggregated list 109 also maintains a delivery status for each electronic commerce order and when receipt of the one-time password 816 fails to correspond to any delivery statuses stored in the aggregated list 109, the one or more processors of the electronic device 100 can determine that use of any one-time password received from that vendor is likely fraudulent.

In still other embodiments, the one or more processors can look at data within the aggregated list 109 to determine whether receipt of the one-time password 816 is associated with fraudulent activity. Illustrating by example, in one or more embodiments the one or more processors determine whether an electronic commerce order stored in the aggregated list 109 identifies the one-time password 816. Where it does not, the one or more processors of the electronic device 100 can determine that use of the one-time password 816 is likely fraudulent.

When the one-time password 816 corresponds to an electronic commerce order stored in the aggregated list 109, the one or more processors of the electronic device 100 can determine whether payment has already been made for that particular electronic commerce order. Where it has, the one or more processors of the electronic device 100 can present a prompt on a user interface indicating that use of the one-time password is likely fraudulent. Said differently, in one or more embodiments step 101 comprises determining that the one-time password 816 corresponds to an electronic commerce order stored in the aggregated list 109, but that payment has already been made for that electronic commerce order. In one or more embodiments, this causes the one or more processors of the electronic device 100 to determine use of the one-time password 816 is likely fraudulent.

Similarly, step 102 can determine whether the one-time password 816 is abnormal when compared to the electronic commerce orders stored in the aggregated list 109. Where it is, the one or more processors of the electronic device 100 can determine that use of the one-time password 816 is likely fraudulent. Step 102 can comprise determining whether the one-time password 816 includes suspicious links or malicious code as well.

Step 102 can also examine the e-commerce portal or website used to trigger the transmission of the one-time password 816 as well. As shown at step 802, what appears to be a legitimate e-commerce portal or website 812 is nothing more than a login credential forwarder that sends a username 813 and password 814 to a truly legitimate e-commerce portal or website 815 so the fraudster 807 can login to the target's account. Accordingly, in one or more embodiments the one or more processors of the electronic device 100 can examine the e-commerce portal or website 812 used to trigger transmission of the one-time password 816 to determine whether it has malicious code, a domain that fails to correspond to vendor short message service addresses or electronic commerce orders stored in the aggregated list 109, or links that fail to correspond to vendor short message service addresses or electronic commerce orders stored in the aggregated list 109. Where any of this is found, the one or more processors can determine that use of the one-time password 816 is likely fraudulent.

At step 103, when a likelihood of fraudulent activity is detected, the one or more processors of the electronic device 100 use the user interface of the electronic device to present a prompt 110 comprising a fraud warning 111 indicating that use of the one-time password 816 is likely fraudulent. Said differently, in one or more embodiments when the receipt of the one-time password 816 associated with an electronic commerce transaction (here represented by delivery of the big fancy package 809) corresponds to fraudulent activity, the one or more processors present a prompt 110 on a user interface of the electronic device 100. As shown in this example, in one or more embodiments the prompt 110 includes a warning 111 of fraudulent activity.

In this illustrative example, the warning 111 includes a warning level 112 based upon a fraud ranking. Here the warning level 112 indicates that there is a ninety-percent chance that the use of the one-time password 816 is associated with fraudulent activity since there is off that chance that the one-time password 816 is not associated with fraudulent activity despite the fact that a correspondence to fraudulent activity has been detected. In one or more embodiments, the warning 111 identifies whether the one-time password 816 corresponds to any of the electronic commerce orders stored in the aggregated list 109.

In this illustrative embodiment, step 105 comprises including a user actuation target 113 in the prompt 110 allowing use of the one-time password 816 to be precluded. In one or more embodiments, when the user actuation target 113 is actuated, the one or more processors of electronic device 100 prevent the one-time password 816 from being revealed.

In this illustrative embodiment, the prompt 110 also includes another user actuation target 114 presented at step 106 allowing the target 808 to override the warning 111 and make use of the one-time password 816. When the authorized user of the electronic device 100 actuates user actuation target 114, the one-time password 816 can be revealed and used since the fraud warning 111 is overridden.

Fortunately, here the one or more processors of electronic device 100 cause presentation of the prompt 110 before the one-time password 816 is revealed. Accordingly, the target 808 immediately actuates the user actuation target 113 provided by the prompt 110 to prevent the one-time password 816 from being revealed. This prevents the fraudster 807 from being able to hack the target's accounts/

As shown at step 108, this fact makes the target 808 become elated. He exclaims, “Not today, sucker! I hope you get caught.” After successfully thwarting the fraud using embodiments of the disclosure, he decides to treat himself to a delicious decaf latte with oat milk.

Other steps can optionally be performed in addition to the presentation of the prompt 110. Illustrating by example, optional step 104 can provide additional details about the fraudster 807 and/or past fraudulent activity. Step 104 can comprise optionally presenting a history of fraudulent transactions associated with any account deemed to be suspicious.

Thus, as illustrated and described a method in an electronic device 100 comprises maintaining, by one or more processors of an electronic device 100 in a memory of the electronic device 100, an aggregated list 109 comprising electronic commerce orders made using credentials of an authorized user of the electronic device 100. The one or more processors detect, from a communication device at step 803, receipt of a one-time password 816 associated with an electronic commerce transaction. At steps 101 and 102, the one or more processors determine whether the receipt of the one-time password 816 associated with the electronic commerce transaction, and/or the e-commerce portal or website used to trigger delivery of the one-time password 816, corresponds to fraudulent activity. Where it does, at step 103 the one or more processors present, at a user interface of the electronic device 100, a prompt 110 comprising a fraud warning 111 indicating that use of the one-time password 816 is likely fraudulent.

While an authorized user of the electronic device 100 can optionally override the fraud warning 111 by actuating a user actuation target 114, in one or more embodiments when this occurs step 106 presents a request for secondary authentication, e.g., facial recognition, entry of a personal identification number, a fingerprint, and so forth, of the authorized user before the one-time password 816 can be revealed.

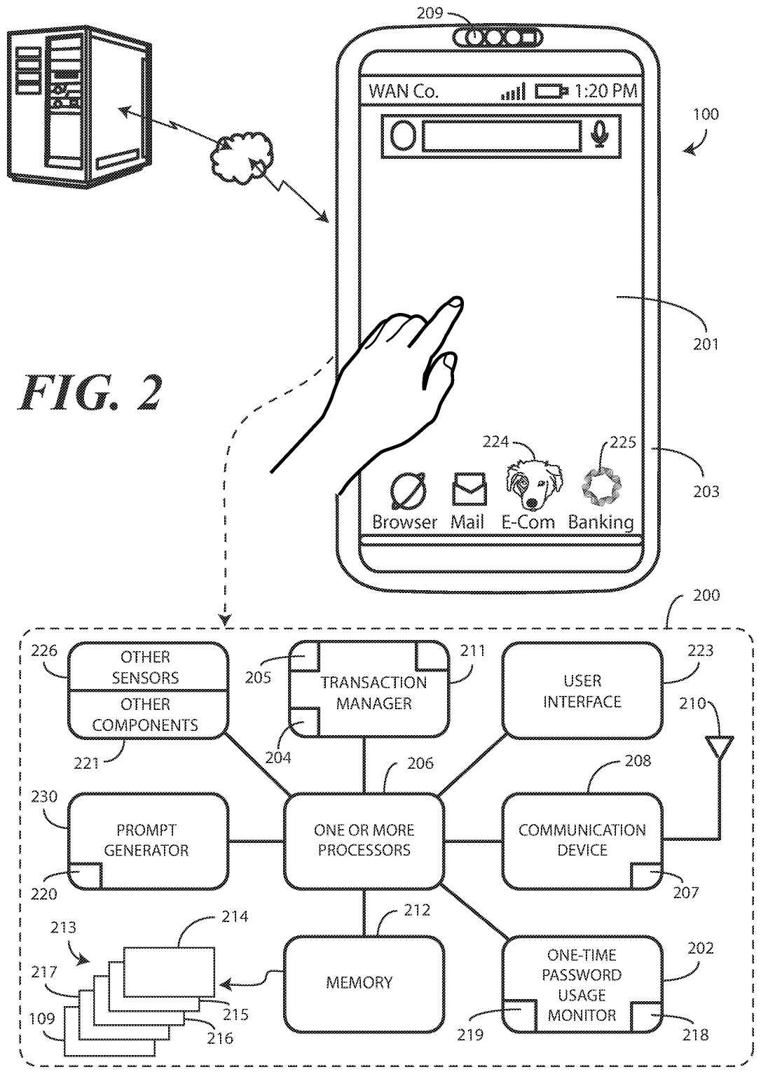

Turning now to FIG. 2, illustrated therein is one electronic device 100 configured in accordance with one or more embodiments of the disclosure. The electronic device 100 of this illustrative embodiment includes a user interface 223. In one or more embodiments, the user interface 223 comprises a display 201, which may optionally be touch-sensitive. The display 201 can serve as a primary user interface 223 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.” In one or more embodiments, these applications comprise one or more e-commerce applications 224 and/or banking applications 225 that allow electronic commerce orders to be placed and financial transactions to be made using the electronic device 100.

Illustrating by example, in one or more embodiments a user can deliver user input to an e-commerce application 224 or a banking application 225 to initiate an electronic commerce order or a financial transaction. In one or more embodiments, when this occurs the communication device 208 transmits a financial transaction initiation communication 204 generated by a transaction manager 211. In one or more embodiments, the financial transaction initiation communication 204 comprises an electronic device identifier from which a financial transaction initiation request was received by the communication device 208. When the financial transaction initiation request includes an account identifier 205, the transaction manager 211 can extract this account identifier 205 from the financial transaction initiation request and include it with the financial transaction initiation communication 204.

In one or more embodiments, the one or more processors 206 are responsible for managing the applications and all personal information received from the user interface 223 that is to be used by the finance application 224 and/or banking application 225 after the electronic device 100 is authenticated as a secure electronic device and the user identification credentials have triggered a login event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen or when the finance application 224 and/or banking application 225 are used with fraudulent activity to wipe the memory 212 clean of any personal data, preferences, or settings of the person previously using the electronic device 100.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, the electronic device 100 includes a one-time password usage monitor 202 and a prompt generator 230. In one or more embodiments, the one-time password usage monitor 202 and a prompt generator 230 can be operable with one or more processors 206, configured as a component of the one or more processors 206, or configured as one or more executable code modules operating on the one or more processors 206. In other embodiments, the one-time password usage monitor 202 and a prompt generator 230 can be standalone hardware components operating executable code or firmware to perform their functions. Other configurations for the one-time password usage monitor 202 and a prompt generator 230 will be obvious to those of ordinary skill in the art having the benefit of this disclosure.

In one or more embodiments, the one-time password usage monitor 202 is configured to interact with an aggregated list 109 stored in the memory 212. The aggregated list 109 comprises electronic commerce orders made using credentials of an authorized user of the electronic device 100 as previously described.

In one or more embodiments, when the communication device 208 receives a one-time password 218, the one-time password usage monitor 202 is configured to determine, using the aggregated list 109, whether the one-time password 218 corresponds to any of the electronic commerce orders stored in the aggregated list 109. Illustrating by example, in one or more embodiments the one-time password usage monitor 202 is configured to determine whether the one-time password 218 corresponds to any of the electronic commerce orders stored in the aggregated list 109 by comparing an origination address 219 parsed from the one-time password 218 with a vendor short message service address associated with the electronic commerce orders stored in the aggregated list 109. When the one-time password 218 fails to correspond to any of the origination addresses stored in the aggregated list 109, the one-time password usage monitor 202 can determine that use of the one-time password 218 is likely fraudulent. The one-time password usage monitor 202 can determine whether use of the one-time password 218 is likely fraudulent in other ways as well, examples of which were described above with reference to FIG. 1.

In one or more embodiments, when the one-time password usage monitor 202 determines that use of the one-time password 218 is likely fraudulent, the one-time password usage monitor 202 triggers prompt generator 230. In one or more embodiments, the prompt generator 230 then causes the user interface 223 to deliver a prompt 220 comprising a fraud warning (111) indicating that use of the one-time password 218 is likely fraudulent.

In one or more embodiments, the prompt 220 comprises an audible prompt. In other embodiments, the prompt 220 comprises a visual presentation presented on the display 201. An example of such a prompt (110) was illustrated above with reference to FIG. 1.

As previously described above with reference to FIG. 1, in one or more embodiments the prompt 220 comprises a user actuation target (examples of user actuation targets are shown in FIG. 2 with reference to the e-commerce application 224 and the banking application 225) that, when actuated, causes fraud warning to be overridden. In one or more embodiments, the one-time password usage monitor 202 is configured to preclude use of the one-time password 218 in an absence of actuation of this user actuation target. When the user actuation target is actuated, thereby overriding the fraud warning, the one-time password usage monitor 202 can reveal the one-time password 218 for use.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

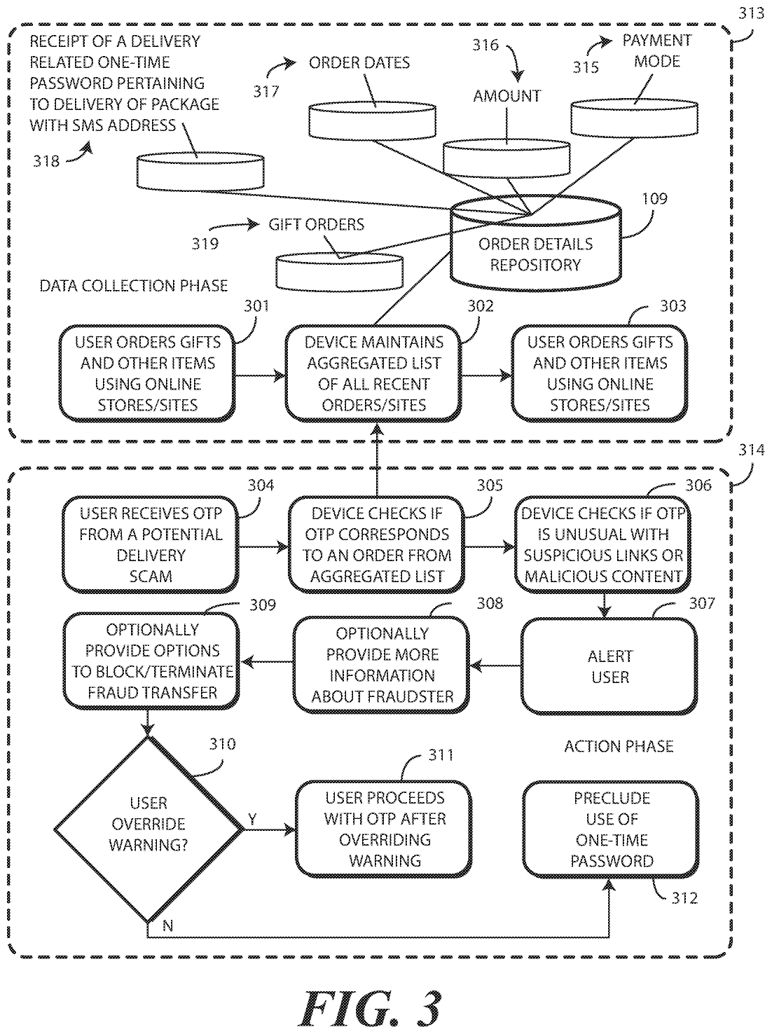

Turning now to FIG. 3, illustrated therein are one or more explanatory method steps in accordance with one or more embodiments of the disclosure. The method steps are broken down into a training phase 313 for the aggregated list 109 and an action phase 314 when the aggregated list 109 is being used to determine whether use of an one-time password may be in conjunction with fraudulent activity.

In the training phase 313, at step 301 an authorized user of an electronic device places electronic commerce orders using legitimate e-commerce portals and websites. In one or more embodiments, the electronic commerce orders placed at step 301 are placed using an electronic device or using accounts that are accessible on the electronic device.

In one or more embodiments, when this occurs step 302 comprises maintain an aggregated list 109 in a memory of the electronic device that stores the electronic commerce orders, electronic commerce transactions associated with the electronic commerce orders, communication corresponding to the electronic commerce orders, and other electronic information associated with the electronic commerce orders.

Illustrating by example, in one or more embodiments the aggregated list 109 stores a payment mode 315 for each electronic commerce order. In one or more embodiments, the aggregated list 109 also stores a purchase price 316 of each electronic commerce order and an indication of whether each electronic commerce order was pre-paid or will be shipped collect on delivery. The aggregated list 109 can store order dates 317 and other information associated with electronic commerce orders. In addition, the aggregated list 109 can store other information described above, examples of which include origination addresses 318 and vendor short message service addresses for each electronic commerce order, a vendor telephone number for each electronic commerce order, delivery statuses of each electronic commerce order, or other information.

In one or more embodiments, the aggregated list 109 even stores gift orders 319 directed to the owner of the electronic device as extracted from electronic signals received by the electronic device. Illustrating by example, if a friend buys the owner of the electronic device a gift, and the electronic device receives electronic signals in the form of a gift notice at step 303, this can be stored in the aggregated list 109 as well.

In one or more embodiments, when a one-time password pertaining to an electronic commerce transaction is received, information such as the vendor short message service address 318 from which the one-time password was received can be stored in the aggregated list 109. Effectively, the aggregated list 109 comprises an aggregated list of recent orders, e-commerce portals and websites from which the electronic commerce orders were made, and any and all electronic communications relating to the electronic commerce orders or electronic commerce transactions stemming therefrom.

In the action phase, at step 304 a communication device of the electronic device receives a one-time password associated with an electronic commerce transaction. At step 305, one or more processors of the electronic device determine, by consulting the aggregated list 109, whether the one-time password corresponds to an electronic commerce order made using credentials of an authorized user of the electronic device stored in the aggregated list 109.

At step 306, the one or more processors can also determine whether the one-time password is unusual. Illustrating by example, in one or more embodiments step 306 comprises determining whether the one-time password originates from an origination address that differs from the origination addresses 318 of the electronic commerce orders stored in the aggregated list 109. Step 306 can also comprise determining whether the one-time password—or an e-commerce portal or website from which transmission of the electronic commerce order was supposedly initiated—to see if includes suspicious links or malicious content.

When either the one-time password fails to correspond to an electronic commerce order of the aggregated list 109 or the one-time password corresponds to an electronic commerce order and the one-time password fails to originate from an origination address 318 associated with any of the electronic commerce orders stored in the aggregated list 109 at step 307 one or more processors of the electronic device present, at a user interface, a prompt comprising a fraud warning indicating that use of the one-time password is likely fraudulent. In one or more embodiments, the prompt instructs the authorized user to examine product associated with the electronic commerce transaction causing the transmission of the one-time password before the one-time password can be revealed.

Optional step 308 can then provide more information about the fraudster. If the prompt includes a user actuation target at step 309 allowing the financial transaction to be terminated, step 312 can comprise precluding the one-time password from being revealed when the user actuation target is actuated, as determined by decision 310. Otherwise, step 311 can comprise allowing the one-time password to be used once the fraud warning of the prompt is overridden.

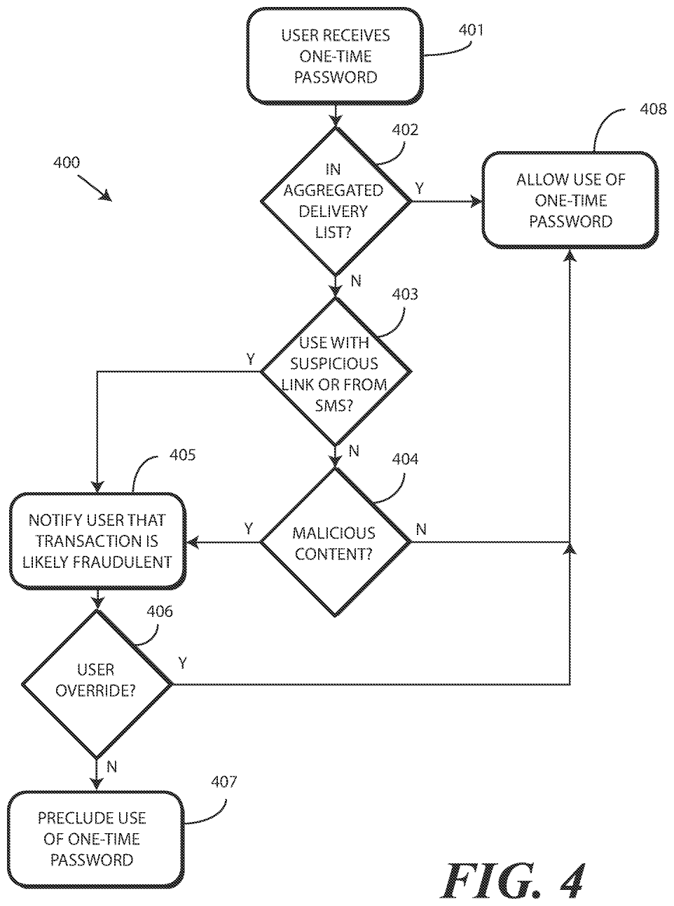

Turning now to FIG. 4, illustrated therein is one explanatory method 400 in accordance with one or more embodiments of the disclosure. At step 401, one or more processors of an electronic device detect receipt of a one-time password associated with an electronic commerce order. At decision 402, the one or more processors determine whether the receipt of the one-time password associated with the electronic commerce transaction corresponds to fraudulent activity.

In one or more embodiments, decision 402 comprises consulting an aggregated list maintained by the one or more processors of the electronic device in a memory of the electronic device. In one or more embodiments, the aggregated list comprises electronic commerce order made using credentials of an authorized user of the electronic device.

In one or more embodiments, the aggregated list maintains a payment mode for each electronic commerce order stored in the aggregated list. In one or more embodiments, decision 402 comprises determining the one-time password fails to correspond to any payment modes stored in the aggregated list.

In one or more embodiments, the aggregated list maintains a vendor short message service address for each electronic commerce order. In one or more embodiments, decision 402 comprises determining the one-time password fails to originate from any vendor short message service address stored in the aggregated list.

In one or more embodiments, the aggregated list maintains a vendor telephone number for each electronic commerce order. In one or more embodiments, decision 402 comprises determining the one-time password fails to originate from any vendor telephone number stored in the aggregated list.

In one or more embodiments, the aggregated list stores one or more gift orders, with the gift order information extracted from electronic signals received by the electronic device indicating that one or more gift orders for the authorized user of the electronic device have been made by one or more remote electronic devices. In one or more embodiments, decision 403 comprises determining that the one-time password fails to correspond to any gift orders stored in the aggregated list.

In one or more embodiments, the aggregated list comprises a delivery status for each electronic commerce order. In one or more embodiments, decision 402 comprises determining that a time of receipt of the one-time password fails to correspond to any of the delivery statuses stored in the aggregated list.

In one or more embodiments, decision 402 comprises determining whether any electronic commerce order stored in the aggregated list identifies the one-time password. Decision 403 can then determine whether the one-time password—or the portal or website into which user credentials of the authorized user of the electronic device were entered to cause the one-time password to be transmitted—are abnormal. This can be done using the electronic commerce orders stored in the aggregated list, searching for malicious code or nefarious links at decision 404, or comparing addresses and domains to origination addresses and vendor short message service addresses stored in the aggregated list. Other techniques for determining whether the one-time password is abnormal at decision 403 will be obvious to those of ordinary skill in the art having the benefit of this disclosure.

If decision 402 is not met and decision 403 is met, or alternatively if decision 402 and decision 403 are not met, but decision 404 is met, step 405 presents a prompt comprising a fraud warning indicating that use of the one-time password is likely fraudulent. Decision 406 determines whether the user overrides the fraud warning. In one or more embodiments, the electronic device is configured to preclude use of the one-time password unless decision 406 determines that the fraud warning is overridden. Where it is, the one-time password can be revealed for use at step 408. Otherwise, step 407 precludes the one-time password from being revealed.

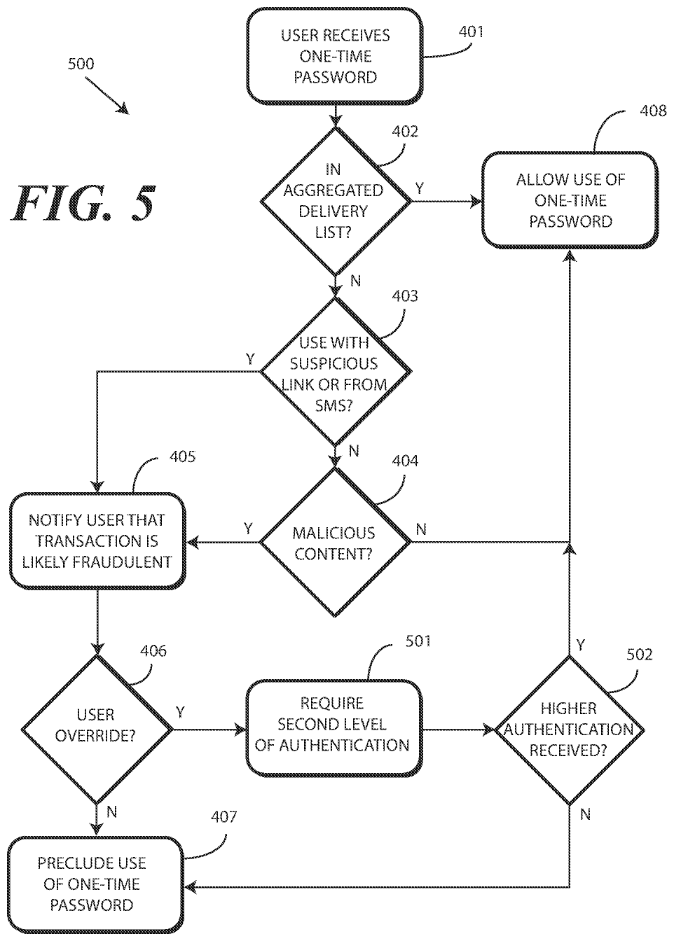

Additional steps can be performed as well just to “double check” to make sure an authorized user of the electronic device really wants the one-time password revealed. Turning now to FIG. 5, illustrated therein is one such additional step.

In FIG. 5, steps 401,405,407,408 and decisions 402,403,404,406 are the same as they were in the method (400) of FIG. 4. Accordingly, they will not be redescribed in the interest of brevity.

The method 500 of FIG. 5 differs from the method (400) of FIG. 4 in that when a fraud warning is overridden, as determined at decision 406, step 501 requests a secondary authentication. Examples of a secondary authentication comprise entry of a personal identification number or password, delivering a fingerprint to fingerprint sensor, providing facial recognition, an iris scan, voice print recognition, expressing a mien during a facial recognition process, and so forth. Other examples of secondary authentication verification mechanisms that can be requested at step 501 will be obvious to those of ordinary skill in the art having the benefit of this disclosure.

Decision 502 determines whether the secondary authentication requested at step 501 is received. Where it is, the one-time password can be revealed for use at step 408. Otherwise, step 407 precludes the one-time password from being revealed.

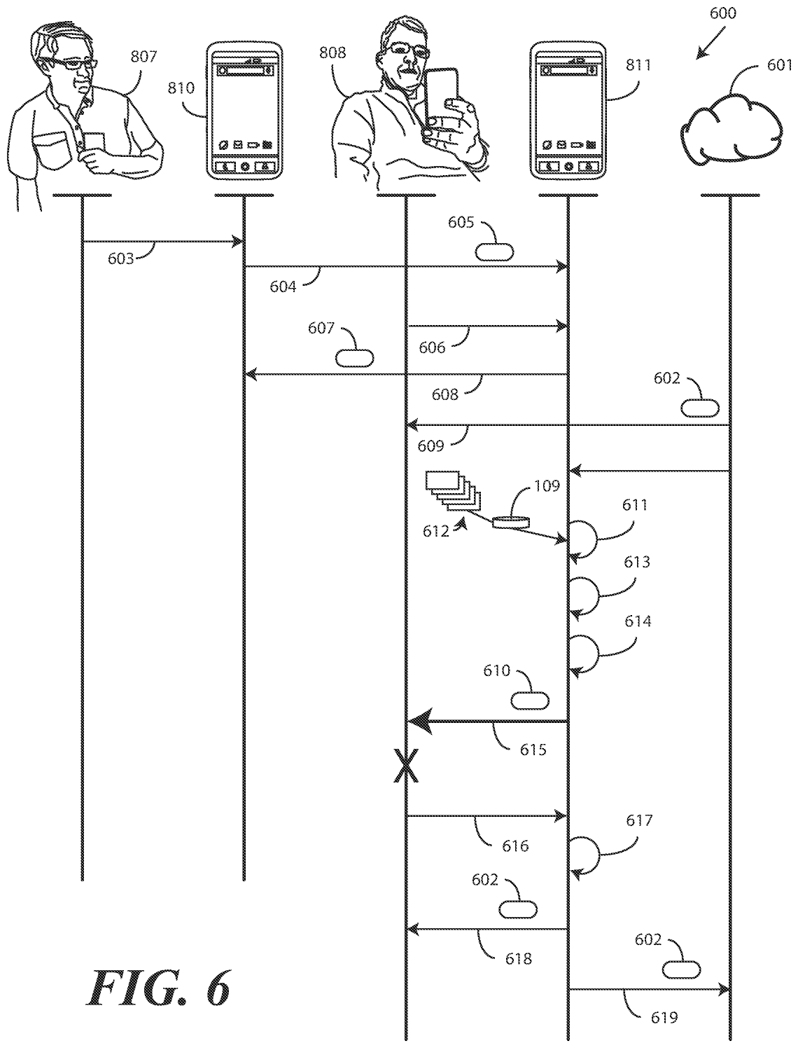

Turning now to FIG. 6, illustrated therein is one explanatory signal flow diagram 600 in accordance with one or more embodiments of the disclosure. The signal flow diagram 600 illustrates methods, electronic devices, and systems that warn a target 808 of potentially fraudulent activity when one-time passwords are received.

In the signal flow diagram 600 of FIG. 6, a fraudster 807 is attempting to defraud the target 808 using the following scheme: initially, the fraudster 807 will allege to have a package or shipment for the target that was shipped “collect on delivery” (C.O.D.). If the target 808 attempts to open the package to inspect whatever may be inside, the fraudster 807 demands that payment be made first. If the target 808 falls for the scam and attempts to pay, the fraudster 807 will deliver user input 603 to his electronic device 810 causing the electronic device 810 to transmit 604 a link 605 to the electronic device 811 of the target 808.

In one or more embodiments, the link 605 appears to point to a legitimate e-commerce portal or website. However, it instead directs the target's electronic device 811 to a fraudulent portal or website. When the target 808 logs input 606, this is a ruse—the login credentials 607 are merely transferred 608 to the electronic device 810 of the fraudster 807 where the fraudster 807 uses the same to login as if the fraudster 807 was the target 808.

Since most people now use two-factor authentication, the fact that the fraudster 807 logs in to a legitimate e-commerce portal 601 or website causes a one-time password 602 to be delivered to the target's electronic device 811. The fraudster 807 will then ask for the one-time password 602 as “confirmation” of payment. If the target 808 shares the one-time password 602, the fraudster 807 now has all the information necessary to ravage the target's account. In short, the scheme is to make the target 808 think they are logging into a legitimate website or e-commerce portal 601 while instead transferring their credentials 607 to the electronic device 810 of the fraudster 807.

Advantageously, the signal flow diagram 600 provides a solution to this problem that would present a prompt 610 to the target 808 warning the target 808 that the use of the one-time password 602 is likely fraudulent. In one or more embodiments, one or more processors of an electronic device maintain 611 an aggregated list 109 in memory that comprises electronic commerce orders 612 made using credentials of an authorized user of the electronic device 811.

This aggregated list 109 can ingest any and all information related to the electronic commerce orders that is received by the electronic device, examples of which include payment modes associated with the electronic commerce orders, text message notifications regarding the electronic commerce orders, email notifications regarding the electronic commerce orders, vendor short message service addresses associated with the emails and text messages corresponding to the electronic commerce orders, delivery statuses of the electronic commerce orders, electronic communications relating to gifts purchased for, and being sent to, the authorized user of the electronic device, or other communications related to the electronic commerce orders.

In one or more embodiments, the one or more processors of the electronic device 811 detect 613, from a communication device of the electronic device 811, receipt 609 of a one-time password 602 associated with an electronic commerce transaction. The delivery of such a one-time password 602 occurs when the authorized user of the electronic device 811 legitimately logs into their accounts in most cases. However, as noted above, it can also be triggered by a fraudster 807 who is attempting to access another person's accounts.

In one or more embodiments, the one or more processors of the electronic device 811 determine 614 whether the receipt 609 of the one-time password 602 associated with the electronic commerce transaction corresponds to fraudulent activity. Where the receipt 609 of the one-time password 602 associated with the electronic commerce transaction corresponds to the fraudulent activity, the one or more processors of the electronic device 811 present, at a user interface of the electronic device, a prompt 610 comprising a fraud warning indicating that the use of the one-time password is likely fraudulent.

The one or more processors can determine 614 whether the receipt 609 of the one-time password 602 associated with an electronic commerce transaction corresponds to fraudulent activity in a variety of ways. Illustrating by example, in one or more embodiments the aggregated list 109 of electronic commerce orders 612 comprises a payment mode used for each electronic commerce order 612. When the receipt 609 of the one-time password 602 fails to correspond with any of the payment modes stored within the aggregated list 109, the one or more processors can determine 614 that use of the one-time password 602 is likely fraudulent.

Similarly, in one or more embodiments the aggregated list 109 comprises a vendor short message service address for each electronic commerce order 612. In one or more embodiments the one or more processors determine 614 whether the one-time password 602 originates from any of the vendor short message service addresses stored in the aggregated list 109. In one or more embodiments, when the one-time password 602 fails to originate from one of these vendor short message service addresses, the one or more processors present 615 a prompt 610 on a user interface indicating that use of the one-time password 602 is likely fraudulent.

In one or more embodiments, the aggregated list 109 also maintains a vendor telephone number for each electronic commerce order 612. In one or more embodiments, when a link 605 used to login fails to include a vendor telephone number included in the aggregated list 109, the one or more processors can present 615 a prompt 610 on a user interface indicating that use of any one-time password 602 received from that vendor is likely fraudulent.

Embodiments of the disclosure can even be used for gift orders. Illustrating by example, in one or more embodiments the communication device of the electronic device 811 can receive electronic signals indicating that one or more gift orders for the authorized user of the electronic device 811 have been made by one or more remote electronic devices. Accordingly, the one or more processors can store communications corresponding to the one or more gift orders in the aggregated list 109. When receipt 609 of a one-time password 602 fails to correspond to any of these gift orders, the one or more processors can present 615 a prompt 610 on a user interface indicating that use of the one-time password 602 is likely fraudulent.

In one or more embodiments, the aggregated list 109 also maintains a delivery status for each electronic commerce order 612. In one or more embodiments, when receipt 609 of the one-time password 602 fails to correspond to any delivery statuses stored in the aggregated list 109, the one or more processors can present 615 a prompt 610 on a user interface indicating that use of the one-time password 602 is likely fraudulent.

In still other embodiments, the one or more processors can look at data within the aggregated list 109 to determine whether receipt 609 of a one-time password 602 is associated with fraudulent activity. Illustrating by example, in one or more embodiments the one or more processors determine whether an electronic commerce order 612 stored in the aggregated list 109 identifies the one-time password 602. Where it does not, the one or more processors can present 615 a prompt 610 on a user interface indicating that use of the one-time password 602 is likely fraudulent. Similarly, where the one-time password 602—or the link 605 e-commerce portal or website used to trigger receipt of the one-time password 602—is abnormal when compared to the electronic commerce orders 612 stored in the aggregated list 109, the one or more processors can present 615 a prompt 610 on a user interface indicating that use of the one-time password 602 is likely fraudulent.

In one or more embodiments the prompt 610 comprises a user actuation target that allows the fraud warning to be overridden. When a user actuates 616 the user actuation target, the one or more processors allow 617 the one-time password 602 to be revealed 618 and/or used 619 with the e-commerce portal 601 to access the target's account.

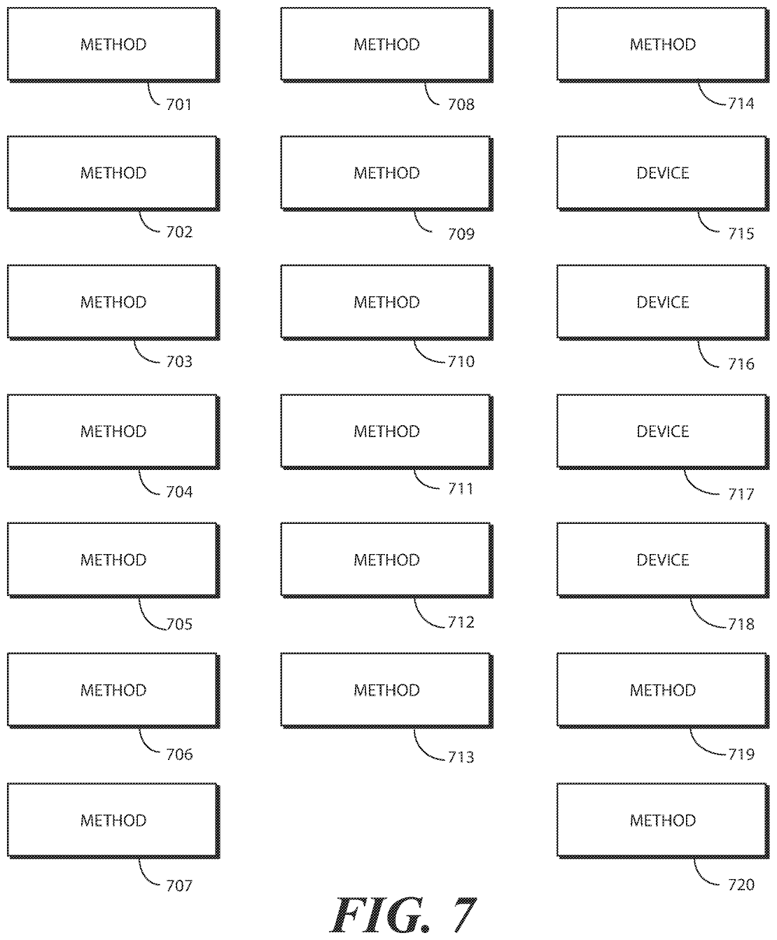

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises maintaining, by one or more processors in a memory of the electronic device, an aggregated list comprising electronic commerce orders made using credentials of an authorized user of the electronic device. At 701, the method detects, by the one or more processors from a communication device of the electronic device, receipt of a one-time password associated with an electronic commerce transaction.

At 701, the method determines, by the one or more processors, whether the receipt of the one-time password associated with the electronic commerce transaction corresponds to fraudulent activity. At 701, when the receipt of the one-time password associated with the electronic commerce transaction corresponds to the fraudulent activity, the method presents, by one or more processors at a user interface of the electronic device, a prompt comprising a fraud warning indicating that use of the one-time password is likely fraudulent.

At 702, the maintaining the aggregated list of electronic commerce orders of 701 comprises maintaining a payment mode for each electronic commerce order. At 703, the determining whether the receipt of the one-time password associated with the electronic commerce transaction of 702 corresponds to the fraudulent activity comprises determining the one-time password fails to correspond to any payment modes stored in the aggregated list.

At 704, the maintaining the aggregated list of electronic commerce orders of 701 comprises maintaining a vendor short message service address for each electronic commerce order. At 705, the determining whether the receipt of the one-time password associated with the electronic commerce transaction of 704 comprises determining the one-time password fails to originate from any vendor short message service address stored in the aggregated list. At 706, the maintaining the aggregated list of electronic commerce orders of 701 comprises maintaining a vendor telephone number for each electronic commerce order.

At 707, the method of 701 further comprises receiving, by the communication device, electronic signals indicating that one or more gift orders for the authorized user of the electronic device have been made by one or more remote electronic devices. At 707, the aggregated list further comprises the one or more gift orders.

At 708, the maintaining the aggregated list of electronic commerce orders of 701 comprises maintaining a delivery status for each electronic commerce order. At 709, the determining whether the receipt of the one-time password associated with the electronic commerce transaction of 708 comprises determining a time of receipt of the one-time password fails to correspond to any delivery statuses stored in the aggregated list.

At 710, the determining whether the receipt of the one-time password associated with the electronic commerce transaction of 701 comprises determining whether an electronic commerce order stored within the aggregated list identifies the one-time password. At 711, the determining whether the receipt of the one-time password associated with the electronic commerce transaction of 701 comprises determining the one-time password is abnormal using the electronic commerce orders stored in the aggregated list.

At 712, the prompt of 701 comprises a user actuation target allowing the fraud warning to be overridden. At 713, the method of 712 further comprises, in response to actuation of the user actuation target, presenting, by the one or more processors at the user interface, a request for secondary authentication.

At 714, the determining whether the receipt of the one-time password associated with the electronic commerce transaction of 701 comprises determining that the one-time password corresponds to an electronic commerce order stored in the aggregated list. At 714, the determining whether the receipt of the one-time password associated with the electronic commerce transaction of 701 comprises determining payment has already been made for the electronic commerce order.

At 715, an electronic device comprises a communication device, a memory, and a user interface. At 715, the electronic device comprises one or more processors operable with the memory, the user interface, and the communication device.

At 715, the memory is configured to store an aggregated list comprising electronic commerce orders made using credentials of an authorized user of the electronic device. At 715, when the communication device receives a one-time password, the one or more processors are configured to determine, using the aggregated list, whether the one-time password corresponds to any of the electronic commerce orders stored in the aggregated list. At 715, when the one-time password fails to correspond to any of the electronic commerce orders in the aggregated list, the one or more processors are configured to present a prompt comprising a fraud warning indicating that use of the one-time password is likely fraudulent.

At 716, the prompt of 715 comprises an audible prompt. At 717, the one or more processors of 715 are configured to determine whether the one-time password corresponds to any of the electronic commerce orders stored in the aggregated list by comparing an origination address parsed from the one-time password with vendor short message service addresses associated with the electronic commerce orders stored in the aggregated list.

At 718, the prompt of 717 comprises a user actuation target allowing the fraud warning to be overridden. At 718, the one or more processors are configured to preclude use of the one-time password in an absence of actuation of the user actuation target.

At 719, a method in an electronic device comprises receiving, by a communication device of the electronic device, a one-time password associated with an electronic commerce transaction. At 719, the method comprises determining, by one or more processors of the electronic device, whether the one-time password corresponds to an electronic commerce order made using credentials of an authorized user of the electronic device stored in an aggregated list of electronic commerce orders in a memory of the electronic device.

At 719, the method comprises also determining, by the one or more processors, whether the one-time password originates from an origination address differing from origination addresses associated with any of the electronic commerce orders stored in the aggregated list. At 719, when either the one-time password fails to correspond to the electronic commerce order or the one-time password corresponds to the electronic commerce order and the one-time password fails to originate from an origination address associated with the any of the electronic commerce orders stored in the aggregated list, the method comprises presenting, by a user interface, a prompt comprising a fraud warning indicating that use of the one-time password is likely fraudulent.

At 720, the prompt of 719 instructs the authorized user to examine product associated with the electronic commerce transaction before the one-time password can be revealed.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
maintaining, by one or more processors in a memory of the electronic device, an aggregated list comprising electronic commerce orders made using credentials of an authorized user of the electronic device;
detecting, by the one or more processors from a communication device of the electronic device, receipt of a one-time password associated with an electronic commerce transaction;
determining, by the one or more processors, whether the receipt of the one-time password associated with the electronic commerce transaction corresponds to fraudulent activity; and
when the receipt of the one-time password associated with the electronic commerce transaction corresponds to the fraudulent activity, presenting, by one or more processors at a user interface of the electronic device, a prompt comprising a fraud warning indicating that use of the one-time password is likely fraudulent.

2. The method of claim 1, wherein the maintaining the aggregated list of electronic commerce orders comprises maintaining a payment mode for each electronic commerce order.

3. The method of claim 2, wherein the determining whether the receipt of the one-time password associated with the electronic commerce transaction corresponds to the fraudulent activity comprises determining the one-time password fails to correspond to any payment modes stored in the aggregated list.

4. The method of claim 1, wherein the maintaining the aggregated list of electronic commerce orders comprises maintaining a vendor short message service address for each electronic commerce order.

5. The method of claim 4, wherein the determining whether the receipt of the one-time password associated with the electronic commerce transaction corresponds to the fraudulent activity comprises determining the one-time password fails to originate from any vendor short message service address stored in the aggregated list.

6. The method of claim 1, wherein the maintaining the aggregated list of electronic commerce orders comprises maintaining a vendor telephone number for each electronic commerce order.

7. The method of claim 1, further comprising:
receiving, by the communication device, electronic signals indicating that one or more gift orders for the authorized user of the electronic device have been made by one or more remote electronic devices;
wherein the aggregated list further comprises the one or more gift orders.

8. The method of claim 1, wherein the maintaining the aggregated list of electronic commerce orders comprises maintaining a delivery status for each electronic commerce order.

9. The method of claim 8, wherein the determining whether the receipt of the one-time password associated with the electronic commerce transaction corresponds to the fraudulent activity comprises determining a time of receipt of the one-time password fails to correspond to any delivery statuses stored in the aggregated list.

10. The method of claim 1, wherein the determining whether the receipt of the one-time password associated with the electronic commerce transaction corresponds to the fraudulent activity comprises determining whether an electronic commerce order stored within the aggregated list identifies the one-time password.

11. The method of claim 1, wherein the determining whether the receipt of the one-time password associated with the electronic commerce transaction corresponds to the fraudulent activity comprises determining the one-time password is abnormal using the electronic commerce orders stored in the aggregated list.

12. The method of claim 1, wherein the prompt comprises a user actuation target allowing the fraud warning to be overridden.

13. The method of claim 12, further comprising, in response to actuation of the user actuation target, presenting, by the one or more processors at the user interface, a request for secondary authentication.

14. The method of claim 1, wherein the determining whether the receipt of the one-time password associated with the electronic commerce transaction corresponds to the fraudulent activity comprises determining:
that the one-time password corresponds to an electronic commerce order stored in the aggregated list; and
payment has already been made for the electronic commerce order.

15. An electronic device, comprising:
a communication device;
a memory;
a user interface; and
one or more processors operable with the memory, the user interface, and the communication device;
wherein:
the memory is configured to store an aggregated list comprising electronic commerce orders made using credentials of an authorized user of the electronic device;
when the communication device receives a one-time password, the one or more processors are configured to determine, using the aggregated list, whether the one-time password corresponds to any of the electronic commerce orders stored in the aggregated list; and
when the one-time password fails to correspond to any of the electronic commerce orders in the aggregated list, the one or more processors are configured to present a prompt comprising a fraud warning indicating that use of the one-time password is likely fraudulent.

16. The electronic device of claim 15, wherein the prompt comprises an audible prompt.

17. The electronic device of claim 15, wherein the one or more processors are configured to determine whether the one-time password corresponds to any of the electronic commerce orders stored in the aggregated list by comparing an origination address parsed from the one-time password with vendor short message service addresses associated with the electronic commerce orders stored in the aggregated list.

18. The electronic device of claim 15, wherein prompt comprises a user actuation target allowing the fraud warning to be overridden, wherein the one or more processors are configured to preclude use of the one-time password in an absence of actuation of the user actuation target.

19. A method in an electronic device, comprising:
receiving, by a communication device of the electronic device, a one-time password associated with an electronic commerce transaction;
determining, by one or more processors of the electronic device, whether the one-time password corresponds to an electronic commerce order made using credentials of an authorized user of the electronic device stored in an aggregated list of electronic commerce orders in a memory of the electronic device;
also determining, by the one or more processors, whether the one-time password originates from an origination address differing from origination addresses associated with any of the electronic commerce orders stored in the aggregated list; and
when either the one-time password fails to correspond to the electronic commerce order or the one-time password corresponds to the electronic commerce order and the one-time password fails to originate from an origination address associated with the any of the electronic commerce orders stored in the aggregated list, presenting, by a user interface, a prompt comprising a fraud warning indicating that use of the one-time password is likely fraudulent.

20. The method of claim 19, wherein the prompt instructs the authorized user to examine product associated with the electronic commerce transaction before the one-time password can be revealed.
